(19) United States
(12) Patent Application Publication
(10) Pub. No.: US 2007/0198943 A1
(43) Pub. Date: Aug. 23, 2007

(54) System and Method for Distributing News Articles and Other Information in an Organization

(76) Inventors: Tom Grason, Lawrenceville, GA (US); Scott Downes, Tucker, GA (US)

Correspondence Address: WITHERS & KEYS FOR BELL SOUTH, P. O. BOX 71355, MARIETTA, GA, 30007-1355, US

(21) Appl. No.: 11/690,824

(22) Filed: Mar. 24, 2007

Related U.S. Application Data
(63) Continuation of application No. 09/985,867, filed on Nov. 6, 2001.

(51) Int. Cl. G06F 3/048

(52) U.S. Cl. 715/776

(57) ABSTRACT

News stories are rendered to readers across non-homogenous computer networks. RSS files are used to provide references to rendering files that define how a news story is to be rendered. The actual data of the news story is identified from information in the RSS file. The RSS file is not changed. An application renders a news story by locating an RSS file containing data related to the news story. Using this data, the application locates a data file containing the actual news story data. Because an application accesses the actual news story data file, the payload problem associated with RSS is overcome without changing the structure of RSS files.

### BACKGROUND

1. Field of the Invention

The present invention relates generally to systems and methods for distributing information over a computer network. More specifically, the present invention relates to systems and methods for distributing news stories, articles or other information to employees and other persons associated with an organization over a computer network.

2. Background of the Invention

It is important for organizations to provide news and other information to persons associated with the organization. In large part, providing such information improves employee morale and productivity because employees feel they are more a part of the organization.

This information can be distributed to persons associated with the organization in numerous ways. For example, organizations can distribute paper (hard copy) in the form of newsletters or mailings informing recipients of the status of the organization as well as events of interest. However, such hard copy distribution of information is expensive and cumbersome.

Consequently, many organizations have implemented various means for distributing news and current events to employees and other persons associated with the organization electronically. These electronic distribution channels include transmission of messages over computer networks such as internets, intranets, extranets and the Internet. One form of electronic dissemination of this information is through electronic mail. Electronic mail messages containing information about the organization are sent over the organization's computer network to recipients.

Another form of electronic dissemination of organization news and events is the use of web sites. A web site containing the news is created, and readers can access the web site to obtain the news. News stories that are published on web sites are created and edited using an authoring tool. Conventional authoring tools require experienced professionals to create news stories that will be incorporated in corporate news letters.

Using such tools, a vendor creates the news story and provides a link to the news story for subscriber web sites. The subscriber web site displays the link to the news story on its web page. When a reader selects the link, the reader is transferred to the vendor's web site. The news story is rendered on a display viewable by the reader. Thus, in these systems, the news story data resides on the vendor web site.

Conventionally, the news story data is a structured text file that conforms to the Extensible Markup Language (XML). XML is a markup language that divides structure and content. An advantage of XML over HTML is that its rules must be rigidly adhered to.

XML is also a language for creating other XML-compliant languages or formats, and is sometimes referred to as a “meta-language”. One type of XML file used in the news distribution context is the Rich Site Summary (“RSS”) format. An RSS file uses XML semantics and structure that are specifically tailored for the application of news story distribution.

A RSS file contains reference links to news stories that are on vendor web sites. For example, a vendor may write news articles covering the telecommunications industry. RSS allows subscriber web sites to provide links to the news generated by the vendor web site to readers surfing the subscriber web site. The vendor web site makes partnership deals with the subscriber web sites. The subscriber web sites devote a portion of their web pages to show links to the news generated by the vendor web site. The vendor benefits when subscribers obtain subscriptions to its news. The subscriber benefits because he does not have to generate news content.

In conventional news distribution systems, the news story data itself is not sent from the vendor web site to the other web sites. Rather, a reference link is displayed to a reader on the subscriber web site. When the reader clicks on the reference link, the reader is transferred to the vendor's web site. The article corresponding to the reference link is then rendered to the user in the user's web browser from the news story data residing on the vendor's web site.

Consequently, subscriber web sites lose control of the reader's viewing experience when the reader is transferred from the subscriber web site to the vendor web site. Losing the reader and losing control of the reader's viewing experience are undesirable for many organizations operating web sites. Moreover, subscriber sites have little or not control over the news story content of the vendor web sites. These problems arising from the conventional paradigm of providing access to news stories to readers through reference links to a vendor's web site rather than sending the news story data are sometimes referred to as the payload problem. SUMMARY OF THE INVENTION

The present invention solves the payload problem by using RSS files in a new way. According to the present invention, the actual data associated with a news story is transferred to a subscriber web site, along with a file containing instructions for rendering the news story data file. From the information conventionally stored in an RSS file, an application in accordance with the present invention derives other information that allows the application to locate a structured text file containing actual news story data and data for rendering that news story. Because the structured text file contains the actual data of the news story, the payload problem associated with the conventional systems that pass RSS reference links only to subscribers is obviated.

Because the news story data is transferred to the subscriber web site, the reader no longer has to be transferred to the vendor web site. Thus, the RSS payload problem is solved.

In one embodiment, the present invention is a system for distributing one or more news stories to a reader. The system comprises a computer accessible to the reader. The computer has a display device viewable by the reader. A web browser is executing on the computer. The web browser has a graphical user interface. A list of the titles of the one or more new stories is displayed to the reader on a web page in the graphical user interface. The system includes a selection device that is used by the reader to select one of the news stories to view. A news story rendering application executes on the computer. The application uses the title of the news story selected by the reader to access a news story rendering file that instructs the web browser how to display data in the graphical user interface. The application also uses the title of the news story to access a news story data file that contains the data associated with the news story. The news story is then rendered to the reader so that it is viewable in the graphical user interface in accordance with the instructions in the news story rendering file and the data in the news story data file.

In another embodiment, the present invention is a method for distributing one or more news stories to a reader. The method begins by displaying a list of news story titles to the reader in a web browser executing on a computer. The method then accepts a selection of one of the news story titles by the reader. The method identifies a file containing a link to a rendering file. Using rendering information, the method determines the location of a data file containing news story data corresponding to the selected news story title. The method then renders the news story data to the reader.

The present invention is described in greater detail in the detailed description of the invention, the appended drawings and the attached claims.

### BRIEF DESCRIPTION OF THE DRAWINGS

FIG. 1 is a schematic diagram of an exemplary computer network architecture on which the present invention can be implemented.

FIG. 2 is an exemplary graphical user interface for an administrator according to an embodiment of the present invention.

FIG. 3 is a flow chart of an exemplary process for creating and managing a news story according to an embodiment of the present invention.

FIG. 4 is an authoring tool according to an embodiment of the present invention.

FIG. 5 is an interface for managing unpublished news stories according to an embodiment of the present invention.

FIG. 6 is an interface for managing news feeds according to an embodiment of the present invention.

FIG. 7 is an exemplary interface for displaying news stories according to an embodiment of the present invention.

FIG. 8 is an exemplary category web page according to an embodiment of the present invention.

### DETAILED DESCRIPTION OF THE INVENTION

The present invention leverages conventional technologies for distributing news story files and uses applications that interpret the information contained in those files in unique ways. Contributors create news story files using authoring tools. These authoring tools allow text formatting such as bolding, italics and underlining. In addition, one or more images can be added to the news stories.

The present invention allows vending and viewing of new stories across heterogeneous server environments. The term “heterogeneous server environment”refers to a computer network architecture containing a mix of technologies used for web servers. For example, at the operating system level, the computer network architecture in a heterogeneous server environment might include Windows NT servers and various UNIX-based servers. Within these servers there could be different applications and different programming languages used to generate applications.

An XML news format is the basic language for communication across web servers. Consequently, using an XML-based structured format for the new stories allows vending of news stories to servers using different technology sets. The vended news stories are rendered to readers using formatting rules local to the server controlling the readers' displays.

The present invention solves the payload problem of RSS by sending the actual data associated with the news story to subscriber web sites. Preferably, the subscriber obtains the news story data from the vendor web site and stores the news story data locally. Consequently, when a reader selects a link associated with a news story, the reader is not transferred to a vendor's web site. Rather, the data of the news story is rendered in the reader's web browser from the subscriber web site. The news story data can be sent from the vendor web site to the client web site at the time of the user request.

The present invention reduces network traffic by eliminating the need for a reader to visit two web sites. Rather, news story data is transferred to the subscriber web site in advance of a reader's request. Preferably, news story data is transferred to a subscriber web site in a step termed “publishing.” Consequently, the requirement for the reader to be transferred to the vendor web site, and the associated network traffic, are eliminated.

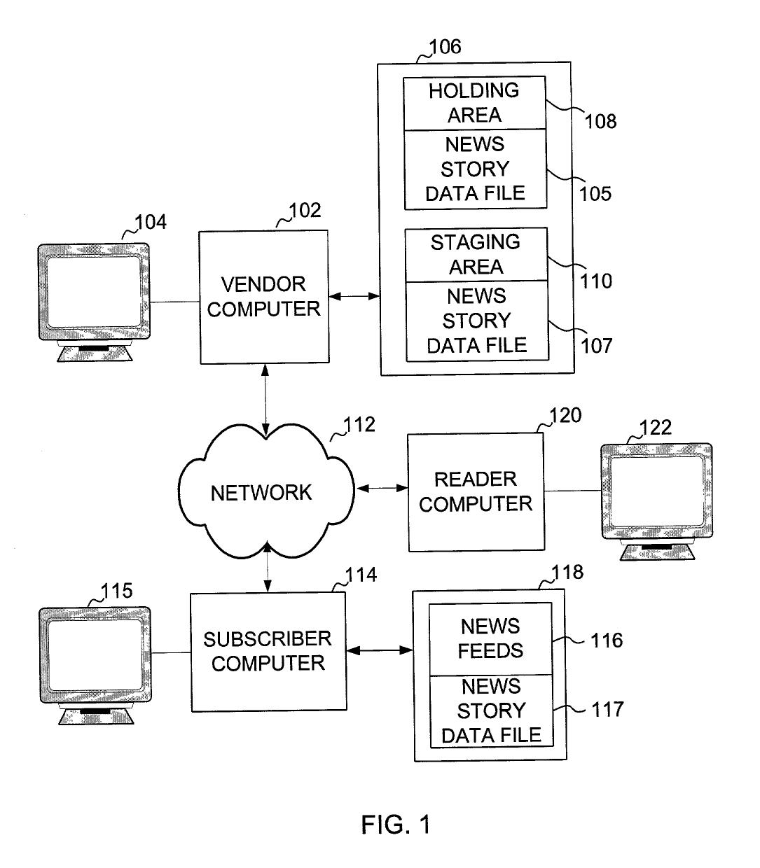

FIG. 1 is a schematic diagram of an exemplary computer network architecture on which the present invention can be implemented. A vendor computer 102 having a display 104 is used by a contributor to create a news story that is stored in a news story data file 105. The created news story data file 105 is stored in a holding area 108 on a mass storage device 106. Mass storage device 106 is any storage device, but preferably mass storage device 106 is a disk drive. While in the holding area 108, the news story can be edited. When the news story is ready for publication, the news story data file is transferred to a staging area 110. FIG. 1 shows a news story data file 107 that is ready for publication and is stored in staging area 110. Periodically, for example once an hour, news stories in staging area 110 are rolled out, or published, to subscribers.

News stories are, in the general case, rolled out over a computer network 112. Computer network 112 can be any computer network, including internets, intranets, LANs, WANs and the Internet. The news story data file is transmitted to a subscriber computer 114 having a display 115. The news story data file is stored as a news feed in a news feed area 116 on a mass storage device 118. FIG. 1 shows a news story data file 117 stored in news feed area 116. In an embodiment of the present invention, vendor computer 102 and subscriber computer 114 are the same, as are displays 104 and 105 and mass storage devices 106 and 118. That is, the vendor and subscriber are co-located and use the same computer equipment and peripherals. Mass storage device 118 can be any mass storage device, but is preferably a disk drive.

Readers can access the news story using a reader computer 120 having a display 122. The reader selects a news story of interest from the subscriber's web page. Selection of the news story causes the news story to be rendered by an application executing on reader computer 120 on display 122 for viewing by the reader.

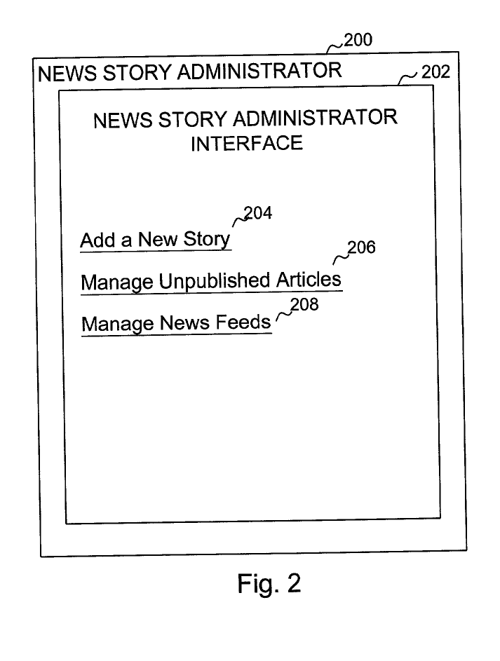

The news story distribution system of the present invention is controlled using a news story administrator 200. News story administrator 200 allows news stories to be created and managed. News story administrator functions include adding news stories, managing unpublished news stories and managing news feeds. FIG. 2 is an exemplary graphical user interface (GUI) 202 for news story administrator 200 according to an embodiment of the present invention. GUI 202 includes links for administering news stories. Link 204 transfers a contributor to a web page for adding a new story. Contributors are authors of news stories. Link 206 transfers an administrator to a web page for managing unpublished articles, i.e., articles that have not yet been rolled out. Link 208 transfers an administrator to a web site for managing news feeds. News feeds are currently-published stories that are available for rendering to readers. News story administrator 200 can be implemented on one computer or distributed over several computers. For example, where the vendor and subscriber computers are separate devices, portions of news story administrator 200 applicable to vendor functions, such as adding news stories and managing unpublished news stores, can be implemented on the vendor computer and portions of the news story administrator 200 applicable to subscriber functions, such as news feed management, can be implemented on the subscriber computer. In an alternative embodiment, news story administrator 200 is implemented on a single computer and its functionality distributed to the vendor and subscriber computers as required.

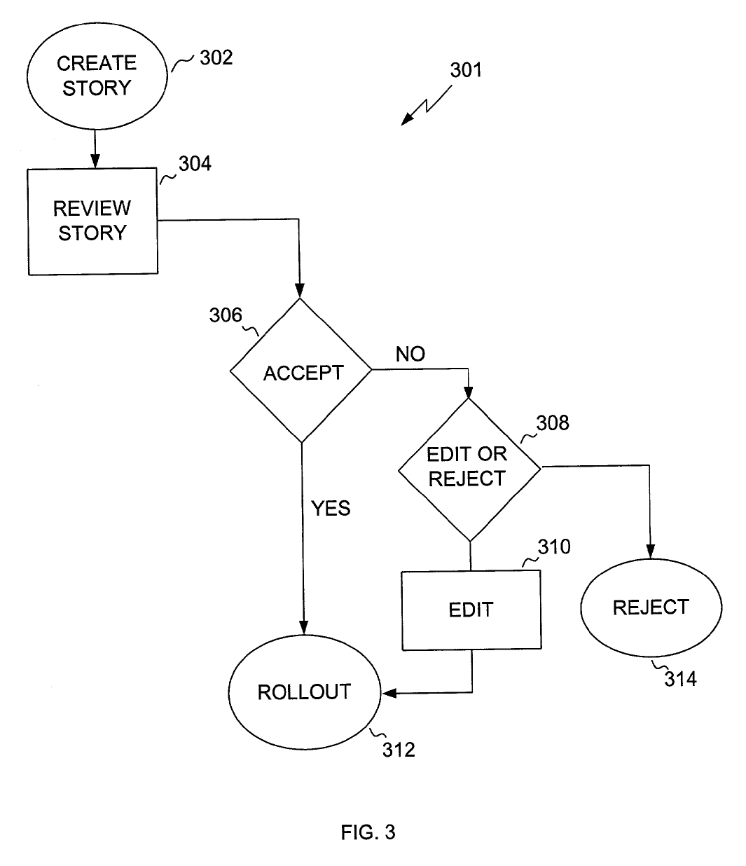

FIG. 3 is a flow chart 301 of a process for creating and managing a news story according to an embodiment of the present invention. In step 302 a contributor creates a news story using an authoring tool (described below). The news story is stored in a news story data file stored in a holding area. The news story data file is a structured text file that includes meta-tags that instruct a rendering application how to present the news story to a reader. In step 304 the story is reviewed. The review can be by an editor or other person responsible for approving or authorizing the story's content. The story is accepted or rejected in step 306.

If the story is accepted in step 306, the file containing the actual news story data is moved from the holding area to a staging area for rollout in step 310. In addition, a JAVA server page (JSP) view file (described below) associated with the news story file is moved to the staging area.

If the story is not accepted in step 306, in step 308 it is determined whether the story will be edited or rejected entirely. If the story is to be edited, it is edited in step 310, and then forwarded to the staging area 312 for rollout. Otherwise, it is rejected in step 314. The news story is said to be published when it is rolled out in step 312. Rollout in step 312 preferably occurs periodically. That is, periodically, e.g., every hour or every thirty minutes, all news stories in the staging area are distributed to subscriber web sites. That is, the news story data file is transferred from the vendor web site to the subscriber web site. No such movement is required where the subscriber and vendor web sites are located on the same computer system. In this case, there is a logical rather than physical transfer. Alternatively, the news stories are published as soon as they are transferred to the staging area. Additional levels of editing and acceptance or rejection can be added as desired for a particular user of the present invention.

As described above, a JSP view file is associated with each news story data file and is stored in with the news story data file. JSP view files are well known to those skilled in the art. Briefly, JSP technology, available from Sun Microsystems, allows for programmatic rendering of HTML views for display using a web browser. Each JSP view file contains programmatic formatting rules to render a file into a web page that can be displayed by the web browser. In the present invention, for example, the reader, editor and contributor all interact with the structured news story data files and RSS files through JSP-rendered views of the data.

In addition, a reference to the JSP view file is stored in an RSS news feed file. The RSS news feed file vends references to web sites that present the news stories to readers.

In addition to JSP-based rendering, news stories can also be rendered using the extensible style sheet transformation (XSL-T) standard. XSL-T is well known to those skilled in the art and is described herein only briefly. XSL-T is a language used to render an XML file to another format. This XSL-T can be used to render news stories in web browsers that cannot render XML-formatted files directly. For example, an XML file containing a reference to an XSL-T translation file can be sent to a client executing a web browser that is unable to render XML files directly. The client loads the XML file. The referenced XSL-T translation file contains a set of XSL-T rules that transforms the XML file to a format that can be rendered to a reader using the web browser. In an embodiment of the present invention, a JSP view file uses XSL-T rules to render an XML news story file to the HTML format so that it can be rendered in a reader's web browser. Some recent web browsers can perform the XSL-T translation natively, and therefore do not require a web server to “pre-translate” and XML file. Using suitable implementations of XSL-T, a news story can be rendered in any file format that can be described programmatically, including, for example, an audio file, an audio file with animation for display on a television and video files.

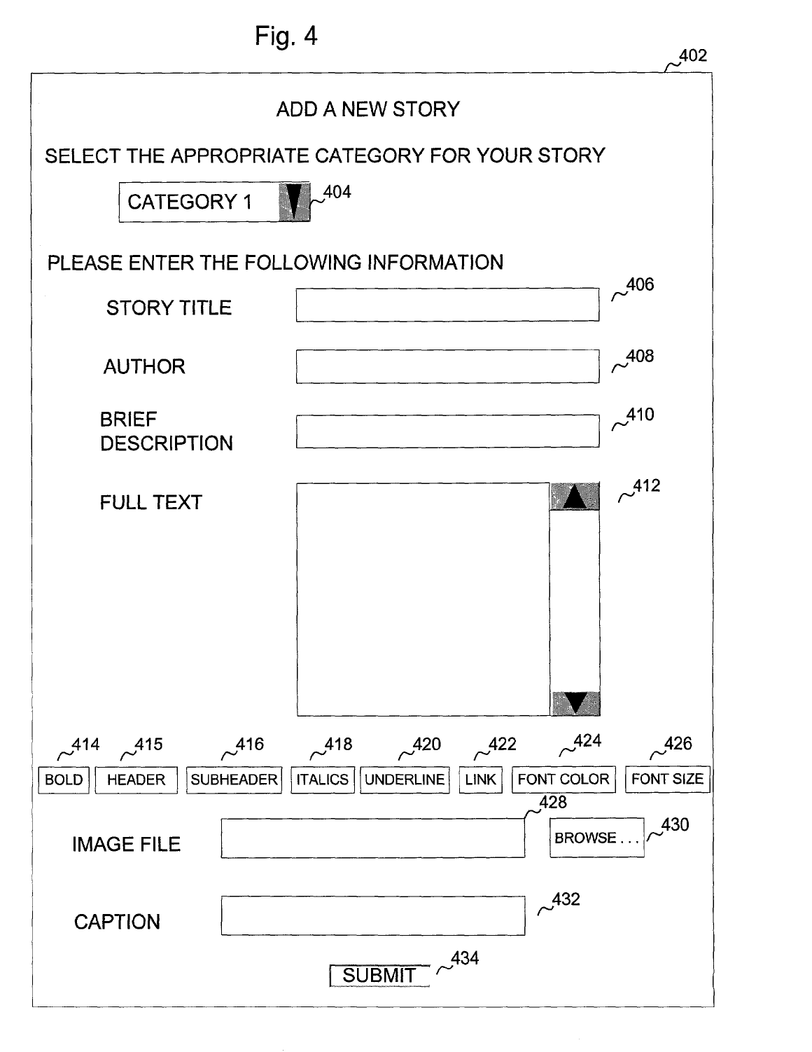

Stories are created using an authoring tool. FIG. 4 illustrates an authoring tool 402 according to an embodiment of the present invention. Authoring tool 402 is presented to a contributor in a web page the contributor is transferred to when the contributor selects link 204. Authoring tool 402 provides the contributor with a variety of choices for creating and presenting a news story to readers.

The contributor can choose a category for the news story by selecting from a pull down menu 404 containing a list of categories. The categories preferably correspond to sections on a screen containing the link to the news story. For example, the category can be “People and Places,” “Corporate News,” “Outside News” or any other category that might be used to categorize news stories that an organization provides to its employees.

The contributor can enter a title for the news story in text window 406. The contributor can then enter the name of the news story's author in text window 408. The contributor can also enter a brief description of the news story in text window 410. The brief description of the news story can be used to entice readers to read the story. The contributor enters the text of the news story in text window 412.

The contributor can include text formatting in any of the text blocks. Most commonly, the text formatting is used in the fall text window 412. In one embodiment of the present invention, the contributor can format text in one of the following ways. The contributor can format text after it is entered by selecting the text and clicking on one of the formatting buttons (described below). Alternatively, the contributor can click on a formatting button, type the text to be formatted, and then click the formatting button again to end the formatting. Other ways of formatting the text would be known to those skilled in the art. For example, pull-down menus could be implemented for providing font characteristics.

There are a variety of formatting options available to the contributor. The contributor can bold text by selecting bold formatting button 414, italicize text by selecting italicize formatting button 418 and underline text by selecting underline formatting button 420. In addition, the contributor can change the color of the text by selecting color formatting button 424 and change the size of the text by selecting size formatting button 426. A header formatting button 415 and a subheader formatting button 416 provide additional test formatting options.

Contributors can also create hyperlinks to other web sites. This is done using a link formatting button 422. When the contributor creates the link, the user is prompted to enter the URL, directory name, file name, or other address associated with the link that the contributor desires to create. The hyperlink generally has descriptive text associated with it.

Images can also be incorporated into news stories created with authoring tool 402. Preferably, only one image is incorporated into a story. In alternative embodiments of the present invention, multiple images can be loaded. To incorporate an image in the news story, the file containing the image is entered in text box 428. If the contributor does not know the file name, the contributor can browse through the directory structure to search for the file by selecting browse button 430. In addition to incorporating the image, the contributor can enter a caption to appear under the picture by entering the caption in text box 432. The image reference is stored in a conventional RSS format to preserve compatibility with applications conforming to RSS.

After the contributor enters the news story using authoring tool 402, the contributor selects a submit button 434. Selecting submit button 434 causes a structured text file containing the news story data to be stored into the holding area.

The news story file structure of the present invention contains markup tags that an application rendering the news story uses to render the news story in a reader's browser. Preferably, the file structure is a subset of an extensible markup language (XML) file format known as news industry text format (NITF). That is, the file structure of the present invention contains some, but not all, of the capability of the NITF format. Any subset of markup tags can be used.

An exemplary news story structured text file according to an embodiment of the present invention is provided in Appendix I. As can be seen in Appendix I, the structured file format of the present invention allows for inline markup in its body element. This allows for the use of XHTML elements within the news story format, e.g., styled text and references to media such as a images, sounds and video. Encapsulating the news story in this structured format enables automated processing to render the news story to a reader.

The markup tags in the exemplary news story file are well known. Some are described below for clarity. The following code segment delimits an “rssitem.” An rssitem provides links to information required to render a particular news story to a reader. The rssitem includes several items.

<rssitem>

<title>Florida school system catches IP wave of the future</title>
<link>/newsstand/peopleandplaces/new/08092,001083859.jsp</link>
<description></description>

</rssitem>

The title is the title of the news story. The link is a reference to a file that is used by an application to render the file to a reader of the news story. As described below, the application rendering the file obtains the location of the data file containing the news story data from the name of the rendering file. The description is a description of the news story entered by the contributor as described above.

The following code segment delimits an image that is to be incorporated into a news story.

<image>

<source>/newsstand/peopleandplaces/images/robert_harris.jpg</source>
<cap>Account Manager Bob Harris</cap>

</image>

The image code segment includes a source indicator that indicates the location of the image file. In addition, the image includes a caption if entered by the contributor in the authoring tool. There is only one image in the preferred embodiment of the present invention whose placement and size are predetermined. In alternative embodiments of the present invention, more than one image can be specified and arbitrarily placed in the news story by the rendering file.

The structured text file that is created by the authoring tool also contains an indication of the version of XML being used, and the version of the news story. In addition, the structured text file incorporates any required character entity sets. For example, the code segment:

<!DOCTYPE story PUBLIC “-//BellSouth Customer Markets//DTD story
0.1//EN” “http://home.customermarkets.bls.com/xml/cm_story.dtd”> >

incorpates the files “cm_{—story.dtd,” shown in Appendix III, which includes character entities for ISO Latin-}1.

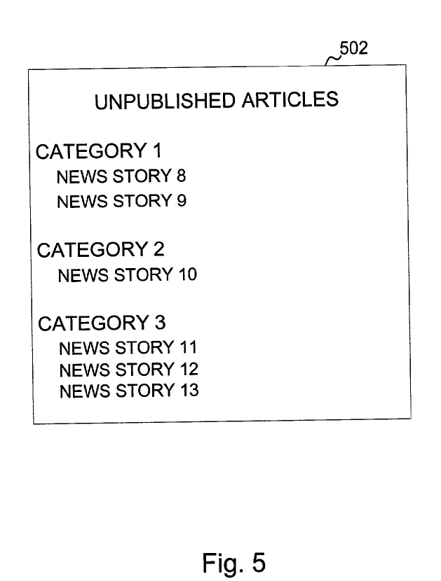

After a news story data file is created, it is stored in a holding area. News stories whose data files are stored in the holding area are considered to be unpublished. Unpublished news stories can be managed. FIG. 5 illustrates an interface 502 for managing unpublished new stories. Preferably, interface 502 presents a list of unpublished articles to an editor or other person responsible for managing the news stories. The news stories are preferably identified by the titles entered by the contributor in authoring tool 402.

News stories in the holding area can be edited prior to publication. An editor selects a news story for editing in a well known manner using a selection device such as a computer mouse or a keyboard. The selected news story is displayed to the editor by authoring tool 302. The editor makes his or her edits and saves the news story file in the holding area for subsequent review or rollout. The editor may also entirely reject the news story.

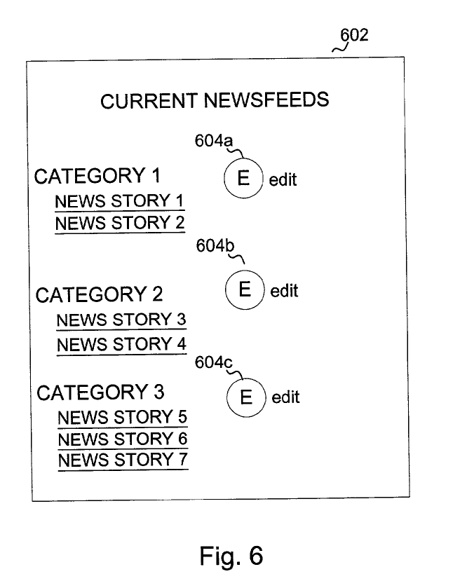

The administrator function of the present invention also allows the order of news stories to be changed. FIG. 6 illustrates an interface 602 according to a preferred embodiment of the present invention for managing news feeds, for example, news story order. By clicking on an edit button 604a, 604b or 604c, an administrator is presented with an interface that allows the administrator to move news stories in priority for a particular category of news stories. The priority of news stories is important for a display such as a category web page (described below), which displays as its lead story the story having the highest priority.

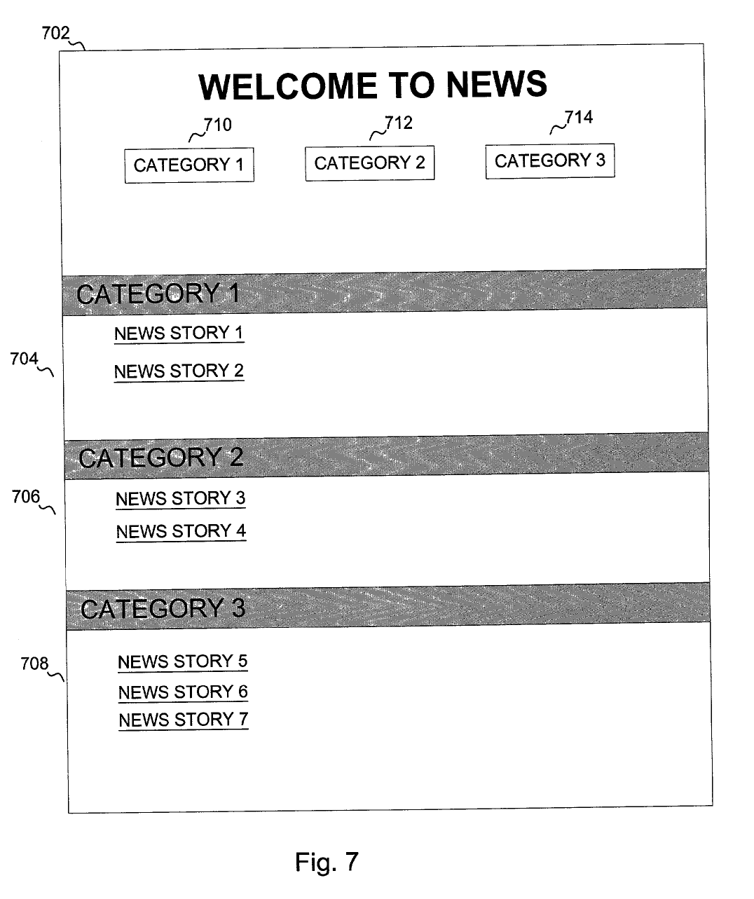

News stories that are published are preferably shown to readers in a graphical user interface (GUI) presented in the prospective reader's web browser. A GUI for showing the news stories to readers according to one embodiment of the present invention is GUI 702 shown in FIG. 7. Preferably, titles of published news stories are displayed to a reader according to categories they are placed into by contributors. For example, news stories 1 and 2 are category 1 news stories. These news stories appear in area 704, which is the portion of the display devoted to displaying titles of category 1 news stories. Likewise, category 2 news stories appear in area 706, which is the portion of the display devoted to displaying titles of category 2 news stories, and category 3 news stories appear in area 708, which is the portion of the display devoted to displaying titles of category 3 news stories.

To see the entire news story, a reader selects the link having the title corresponding to the news story. For example, the reader can click on the news story with a pointing device such as a computer mouse and associated cursor. Alternatively, the reader can use a keyboard to type in the title of the news story. The entire news story is then rendered in the reader's web browser according to the rendering file and inferentially-located news story data file.

Readers can also select a particular category of news stories in which they are interested. A reader selects a particular category of news stories by choosing a button associated with that category. For example, button 710 is associated with news stories in category 1, button 712 is associated with news stories in category 2, and button 714 is associated with news stories in category 3.

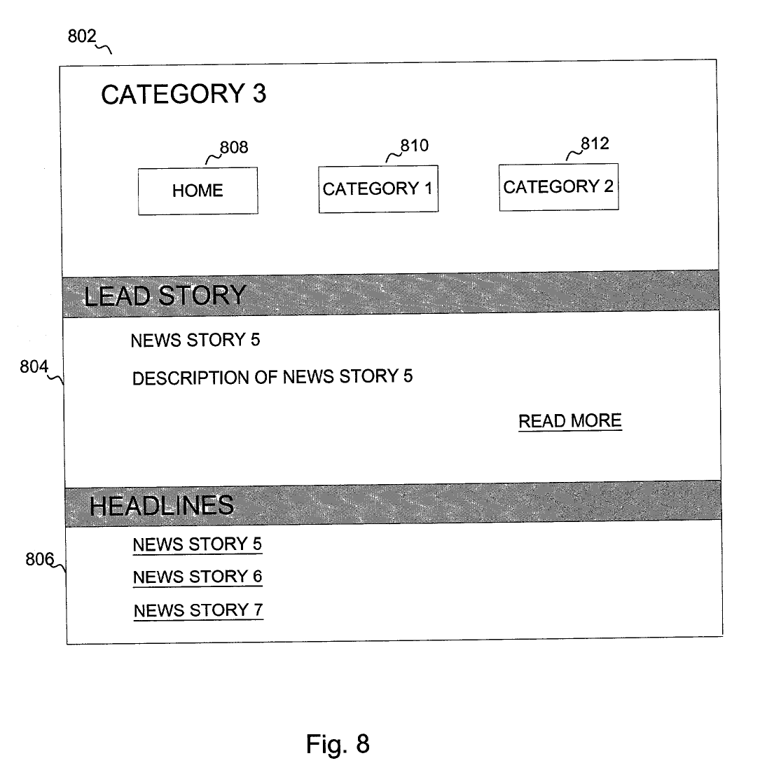

When a reader chooses a particular category of news stories in which he or she is interested, the user is presented with a category web page pertaining to that category of stories. Preferably, the category web page shows the lead story in the selected category of stories with a description of that story, as well as the titles of all of the news stories in the selected category of news stories. FIG. 8 is an exemplary category web page 802 illustrating what is shown to a user when the user selects a particular category of news stories according to a preferred embodiment of the present invention. In this case, the reader has selected category 3.

When the reader selects button 714 associated with category 3, the reader is sent to a category web page for category 3 such as category web page 802 shown in FIG. 8. A lead story portion 804 of category web page 802 is devoted to the lead story. Preferably the lead story is the first story listed in the category. For category 3, news story 5 is the first listed news story. Consequently, news story 5 is the lead story for category 3. In addition, to listing the title of the lead story, category web page 802 provides a description of the lead news story in lead news story portion 804. For example, the description is a predetermined number of sentences of the news story, for example the first three sentences of the news story. Alternatively, the description is any description entered by the contributor in the description field 410 of authoring tool 402. The entire news story is displayed to the reader when the reader clicks on the “read more” link.

A category headlines portion 806 of category web page 802 lists the headlines of all published news stories associated with the category. In the present example, headlines (titles) for news stories 5, 6 and 7 are listed in category headlines portion 806. If the reader selects any of the headlines (for example, by clicking on the headline), the full news story corresponding to the selected headline is displayed to the reader. In an alternative embodiment of the present invention, only the titles of news stories other than the lead news story for the selected category are displayed in portion 806.

Category web page 802 also provides a user with the ability to transfer to other web pages. For example, by clicking on button 808, the reader is transferred to a home page. Clicking on button 810 transfers the user to a category web page associated with category 1. Clicking on button 812 transfers the user to a category web page associated with category 2.

As described above, RSS suffers from the payload problem because it provides only a link to news story data, not the news story data itself. The RSS payload problem prevents a subscriber web site from controlling content. Moreover, the reader is transferred from the subscriber web site to the vendor's web site to retrieve the news story data. Thus, the subscriber web site can lose the reader entirely. Moreover, network traffic can be increased due to transferring readers to different web sites. Another problem with RSS payloads is backward compatability. A variety of products exist that manage, translate and/or process RSS files. These products depend on the immutability of the RSS format. For this reason, new techniques that interact with RSS files should not require custom or proprietary changes to this well-known format. The present invention solves the RSS payload problem as described below.

The present invention uses application logic for handling interactions between RSS and the structured data files associated with news stories. Conventionally, RSS sends a link between a syndicator (vendor) and a subscriber (consumer). The syndicator, or vendor, creates the news story. Thus, the syndicator provides an RSS file at a location known to subscriber applications responsible for rendering news story data files. For example, the URL http://mywebserer.com/foo/bar.rss could serve as the reference location for the syndicator site's RSS file. In this manner, other sites can find the data and even request subsets of this data. For example, http://mywebserver.com/foo/bar.rss?number=15&type=Articles+About+Cooking might be a link to a subset of food-related articles about cooking. In conventional uses of the RSS file, the syndicator does not vend the stories themselves. Rather, the syndicator vends only references to the stories. RSS files are used for communicating across web servers syndicating references to the data.

By contrast, the RSS file used in the present invention provides a link to a rendering file, and obtains the location of news story data from the contents of the RSS file. Moreover, the present invention maintains compatibility with conventional RSS files.

An exemplary RSS file for use in the present invention is provided in Appendix II. As can be seen from the exemplary RSS file provided in Appendix II, the structure of a conventional RSS file is preserved by the present invention. This is required so that applications that expect the conventional RSS structure will work with the present application, and may avoid copyright issues associated with changing RSS. Thus, the exemplary RSS file contains titles of news stories and links to those news stories.

The present invention uses RSS in a unique way to overcome the payload problem inherent in conventional RSS. The present invention combines RSS syndication with a content management system. According to the present invention, RSS is not used solely to provide a URL where a reader is transferred to view the news story. Rather, the RSS file contains a directory listing to a rendering file, used by an application to render a news story to a reader. For example, the file can be a JSP file. In addition, the application that renders the news story to the reader locates the file containing the actual data of the news story.

The news story data is located in a separate directory devoted to news story XML data files. Preferably, the file name of the data file containing the news story data corresponds to the file name of the JSP file. In one embodiment of the present invention, the names are assigned on the basis of date and time. It would be apparent to those skilled in the art that any relative naming convention that allows an application to locate a news story data file by inference from information in a conventional RSS file can be used in the present invention.

To render a selected news story to an end user, an application accesses the RSS file to find the directory reference associated with the JSP file used to render the selected news story. This can be done in any number of ways that would be known to those skilled in the art. For example, the application can compare the titles in the RSS file to the title associated with the news story that the user selected. When there is a match, the application uses the directory reference associated with the matching title as the file containing the JSP view file. Using the name of the JSP view file, the application looks in the directory devoted to the XML news story data for the XML file having the same name as the JSP file. For example, if the name of a JSP file listed in the RSS file is c:/news/category1/07262,001163Y36.jsp, the corresponding XML file containing the news story data is preferably located at c:/news/category1/items/07262,01163836.xml. The application then accesses the corresponding XML file containing the news story data and renders the news story according to the JSP file and the news story data.

One use of the present invention is to generate a category web page 602 solely using information provided in the RSS file. The application creates a category web page by looking at an RSS file containing the news stories. Preferably, the RSS file is specific to a particular category, in this case category 3. Category-specific RSS files are preferably named to identify the category with which they are associated, for example “category3.RSS.” The application gets a list of the news stories for category 3 from the “category3.RSS” RSS file, as well as links to rendering (JSP) files for those stories, and possibly descriptions. The application uses information provided in the link for the rendering file to inferentially locate the XML files containing the news story data. As described above, the information is preferably based on the name of the JSP file. The application then obtains a predetermined number of sentences of the news story in the lead story description and renders those sentences in the lead story area of the category web page. Alternatively, the present invention can display the description of the news story if desired in the lead story area.

The RSS file does not have to be category specific. Rather, an RSS file can contain news stories associated with a plurality of categories. In this case, the application using the RSS file would have to cull through the items in the RSS file to extract those related to a particular category.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1-40. (canceled)

41. A computer system for distributing one or more news stories to a reader, comprising:
a computer accessible to the reader, the computer having a display device viewable by the reader;
a web browser executing on the computer, the web browser having a graphical user interface for receiving news story data comprising a news story from a subscriber web site in response to a user request, wherein the news story data is published from a news vendor web site to the subscriber web site; and
a news story rendering application executing on the computer that renders the news story in the news story data for display in the graphical user interface.

42. The computer system of claim 41, wherein the news story data is published from the news vendor web site to the subscriber web site in advance of the user request.

43. The computer system of claim 41, wherein the news story data is published from the news vendor web site to the subscriber web site upon receiving the user request.

44. The computer system of claim 41, wherein the news story data is periodically published from the news vendor website to the subscriber web site.

45. The computer system of claim 41, wherein the news story is rendered in a file format, the file format comprising at least one of an audio file and a video file.

46. The computer system of claim 41, wherein the news story data is selected from a list of titles corresponding to one or more news stories displayed in the graphical user interface.

47. The computer system of claim 41, wherein the news story data is selected from a category web page, the category web page listing a title and a description associated with the news story, the description comprising a predetermined number of sentences of the news story.

48. A method for creating and distributing news stories, comprising:
receiving news story data comprising a news story on a vendor web page generated by a vendor computer;
in response to receiving the news story data, creating a structured text file containing the news story data;
storing the news story data in a holding area on the vendor computer; and
publishing the news story data from the holding area on the vendor computer to a web browser comprising a graphical user interface for rendering the news story on a reader computer in communication with the vendor computer.

49. The method of claim 48, wherein receiving news story data comprises receiving at least one formatting command on the vendor web page to format text associated with the news story data.

50. The method of claim 48, wherein receiving news story data comprises receiving a formatting command on the vendor web page to create one or more hyperlinks to at least one web site.

51. The method of claim 48, wherein receiving news story data comprises receiving at least one image file comprising an image to be incorporated into the news story.

52. The method of claim 51 further comprising storing a reference to the at least one image file in a RSS file format.

53. The method of claim 48, wherein creating a structured text file containing the news story data comprises creating a news industry text format (NTIF) file to enable automated processing in rendering the news story on the reader computer.

54. A computer-readable medium comprising computer executable instructions which, when executed on a computer, will cause the computer to perform a method for creating and distributing news stories, the method comprising:
receiving news story data comprising a news story on a vendor web page generated by a vendor computer;
in response to receiving the news story data, creating a structured text file containing the news story data;
storing the news story data in a holding area on the vendor computer; and
publishing the news story data from the holding area on the vendor computer to a web browser comprising a graphical user interface on a reader computer in communication with the vendor computer for displaying the news story to a reader.

55. The computer-readable medium of claim 54, wherein receiving news story data comprises receiving at least one formatting command on the vendor web page to format text associated with the news story data.

56. The computer-readable medium of claim 54, wherein receiving news story data comprises receiving a formatting command on the vendor web page to create one or more hyperlinks to at least one web site.

57. The computer-readable medium of claim 54, wherein receiving news story data comprises receiving at least one image file comprising an image to be incorporated into the news story.

58. The computer-readable medium of claim 57 further comprising storing a reference to the at least one image file in a RSS file format.

59. The computer-readable medium of claim 54 further comprising receiving edits to the news story on the vendor web page prior to publication.

60. The computer-readable medium of claim 54, further comprising rejecting the news story on the vendor web page.
